(19) United States
(12) Patent Application Publication
(10) Pub. No.: US 2006/0043071 A1
(43) Pub. Date: Mar. 2, 2006

(54) System and method for process control using in-situ thickness measurement

(76) Inventors: Liang-Lun Lee, Taipei City (TW); Chen-Shien Chen, Hsinchu (TW); Yai-Yei Huang, Hsinchu (TW); Chyi S. Chern, Tainan (TW)

Correspondence Address: BIRCH STEWART KOLASCH & BIRCH, PO BOX 747, FALLS CHURCH, VA, 22040-0747, US

(21) Appl. No.: 10/932,194

(22) Filed: Sep. 2, 2004

(51) Int. Cl. C03C 15/00

(52) U.S. Cl. 216/88; 451/5; 711/4

(57) ABSTRACT

A fabrication system. A plating tool generates a layer of conductive material on a substrate. A polishing tool uses a mechanical mechanism to remove the conductive material from the substrate. A metrology tool measures an electromagnetic signal induced in the conductive material using a non-destructive testing mechanism. A controller, coupled to the polishing and metrology tools, determines residue thickness and removal rate of the conductive material during the polishing process according to the measured electromagnetic signal, and adjusts process parameters for the plating and polishing tools accordingly.

### BACKGROUND

The present invention relates to process control and particularly to adjusting process parameters for Chemical-Mechanical Polishing (CMP) and plating processes using in-situ thickness measurement.

A continued emphasis on semiconductor device miniaturization, leading to the technological evolution of Large Scale Integration (LSI), Very Large Scale Integration (VLSI) and Ultra Large Scale Integration (ULSI), has resulted in shorter inter-linear device distances. As a result of this ever shallower image depth, target surfaces must be created with enhanced flatness. Increased semiconductor device density is frequently implemented using multi-layered configurations, further leading to demands of increased planarity of the surface over which additional semiconductor device features are created.

A polishing system that uses chemical slurry is commonly known as a chemical mechanical polishing (CMP) system. Currently, CMP is widely used for planarizing inter-level dielectrics and metal layers. A CMP process is performed by sliding a wafer surface on a relatively soft polymeric porous pad flooded with chemically active slurry containing abrasive particles of sub-micron diameter. The mechanical properties of the polishing pad and its surface morphology control the quality and efficiency of CMP process. The pad surface morphology controls the partition of down pressure between the abrasive particles and direct wafer/pad contact. In addition, the polishing pad behaves in an elastic and/or viscoelastic manner under the applied pressure, which is thought to affect the WIWNU (within wafer non-uniformity) or planarity. In practice, it is not clear what pad property should be measured to characterize the polishing results.

FIGS. 1A to 1C illustrate surface profiles of a film in different stages during a conventional CMP process. Referring to FIG. 1A, a layer of copper (Cu) is deposited on a substrate, wherein the Cu layer is represented as a shaded area 11a, and the substrate is represented as a clear area 15a. In a multi-phase CMP process, bulk of Cu is removed in a first polishing phase, leaving a surface profile as shown in FIG. 1B, wherein the Cu layer is represented as a shaded area 11b, and the substrate is represented as a clear area 15b. A second polishing phase is then executed until an end signal is detected by an end-point detector. As shown in FIG. 1C, the substrate is represented as an area 15c, wherein a part 111c with remaining Cu residue is under-polished, and an area 115c with a dished appearance is over-polished. The second polishing phase removes remaining Cu form the substrate, without compensating surface variations resulting from the first polishing phase.

Hence, there is a need for a process control system that addresses within wafer non-uniformity arising from the existing CMP technology.

### SUMMARY

It is therefore an object of the invention to provide a system and method for real time process control to improve process accuracy for film plating and removal. To achieve this and other objects, embodiments of the present invention provide a system and method employing an eddy current testing to monitor surface characteristics of a substrate during a polishing process, and using the surface characteristics to adjust process parameters of plating and polishing tools performing plating and polishing processes.

According to an embodiment of the invention, a fabrication system comprising a plating tool, a polishing tool, a metrology tool, and a controller is provided. The plating tool generates a layer of conductive material on a substrate. The polishing tool uses a mechanical mechanism to remove the conductive material from the substrate. The metrology tool measures an electromagnetic signal induced in the conductive material using a non-destructive testing mechanism. The controller, coupled to the polishing and metrology tools, determines residue thickness and removal rate of the conductive material during the polishing process according to the measured electromagnetic signal, and adjusts a process parameter for the polishing tool accordingly.

Another embodiment of the invention provides a processing method executed in a fabrication system. First, a substrate covered with a layer of conductive material is provided. Second, a first polishing run, defined by a first process parameter, is performed to remove the conductive material using a mechanical mechanism. An electromagnetic signal induced in the conductive material is measured using a non-destructive testing mechanism. A residue thickness and removal rate of the conductive material during the first polishing run are then determined according to the measured electromagnetic signal. The first process parameter for the polishing tool is then adjusted accordingly. Next, a second polishing run defined by the adjusted process parameter is performed. Additionally, a second process parameter for a plating tool is determined, and a plating process is performed as defined by the second process parameter.

The above-mentioned method may take the form of program code embodied in a tangible media. When the program code is loaded into and executed by a machine, the machine becomes an apparatus for practicing embodiments of the invention.

A detailed description is given in the following embodiments with reference to the accompanying drawings.

### BRIEF DESCRIPTION OF THE DRAWINGS

Embodiments of the present invention can be more fully understood by reading the subsequent detailed description and examples with references made to the accompanying drawings, wherein:

FIGS. 1A to 1C illustrate surface profiles of a film in different stages during a conventional CMP process;

FIG. 2 is a schematic view of a fabrication system according to embodiments of the present invention;

FIG. 3 is a flowchart of the processing method according to embodiments of the present invention;

FIGS. 4A and 4B illustrate surface profiles of a film in different stages during a CMP process;

FIGS. 5A and 5B illustrate scatter plots and regression lines according to a first and second regression models according to the embodiments; and

FIG. 6 is a diagram of a storage medium for storing a computer program providing the process control method according to embodiments of the present invention.

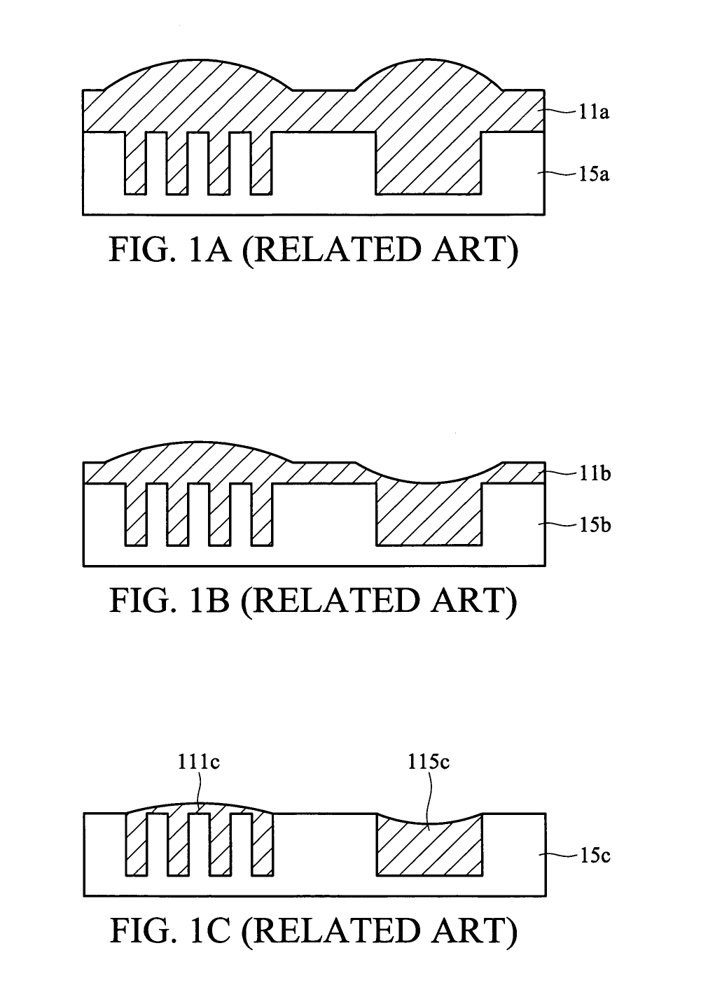

### DETAILED DESCRIPTION

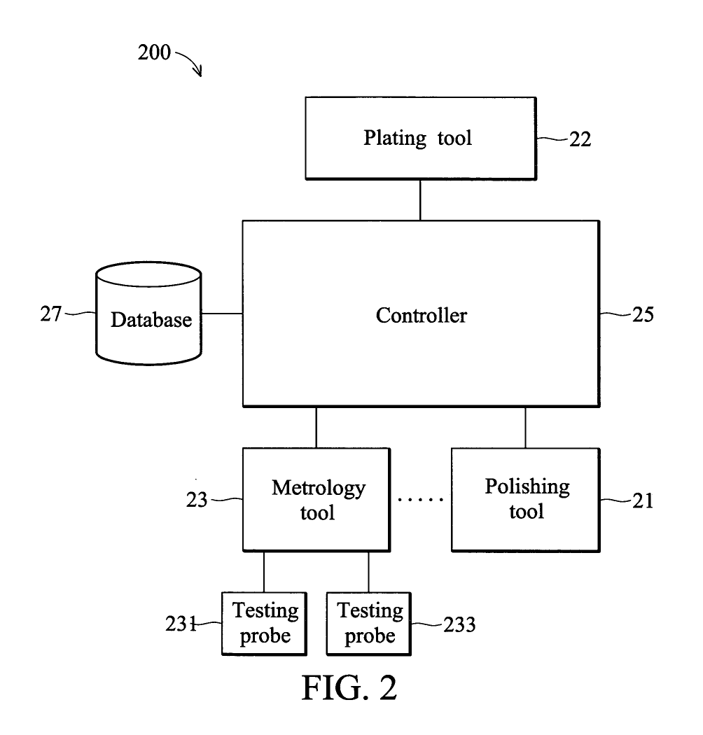

Embodiments of the present invention will now be described with reference to FIGS. 2 to 6, which in general relate to a process control system within a fabrication system. While the embodiments disclosed operate with a Cu-removal CMP process, it is understood that any metal-film removal process polishing a face-down substrate may operate with the present invention.

FIG. 2 is a schematic view of a fabrication system according to embodiments of the present invention. Fabrication system 200 is a semiconductor fabrication system performing metal-plating and CMP processes on a semiconductor wafer.

The fabrication system 200 comprises a polishing tool 21, a plating tool 22, a metrology tool 23, and a controller 25. The plating tool 22 generates a layer of conductive material on a substrate The polishing tool 21 uses a mechanical mechanism to remove the layer of conductive material, such as copper (Cu), from the substrate. According to this embodiment, the polishing tool 21 is a chemical-mechanical polishing (CMP) tool, applying variable downward pressure on different polishing zones, resulting in different removal rates for different polishing zones. The metrology tool 23 measures an electromagnetic signal generated from the Cu layer using a non-destructive testing method. According to this embodiment, the metrology tool 23 is an eddy current testing device comprising two testing probes 231 and 233 measuring Cu film thickness in different polishing zones. The testing probe 231 is disposed on the central area of the polished surface, while the testing probe 233 is disposed on an edge area thereof. Polishing tool 21, plating tool 22, and metrology tool 23 are connected to controller 25. Polishing tool 21 and metrology tool 23 cooperate but may not be connected directly. The controller 25 determines residue thickness and removal rate of Cu during the polishing process according to the measured electromagnetic signal and a preset regression model specifying correlation therebetween, and adjusts process parameters for polishing tool 21 and plating tool 22 accordingly. The preset regression model is stored in a database 27, connected to controller 25.

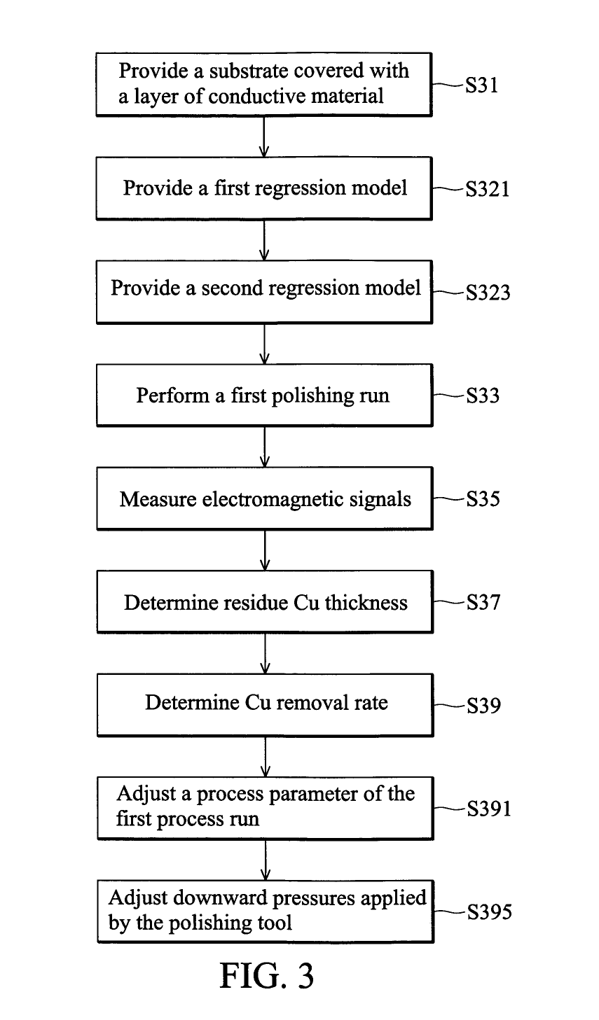

FIG. 3 is a flowchart of a processing method according to embodiments of the invention.

First, a substrate covered with a layer of conductive material is provided (step S31). The conductive material can be any metal deposited on a substrate during semiconductor manufacture, such as copper (Cu).

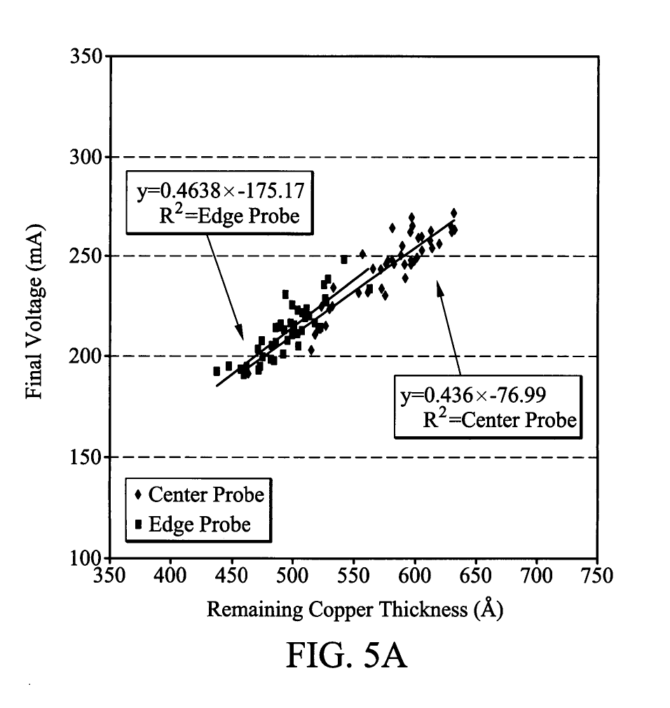

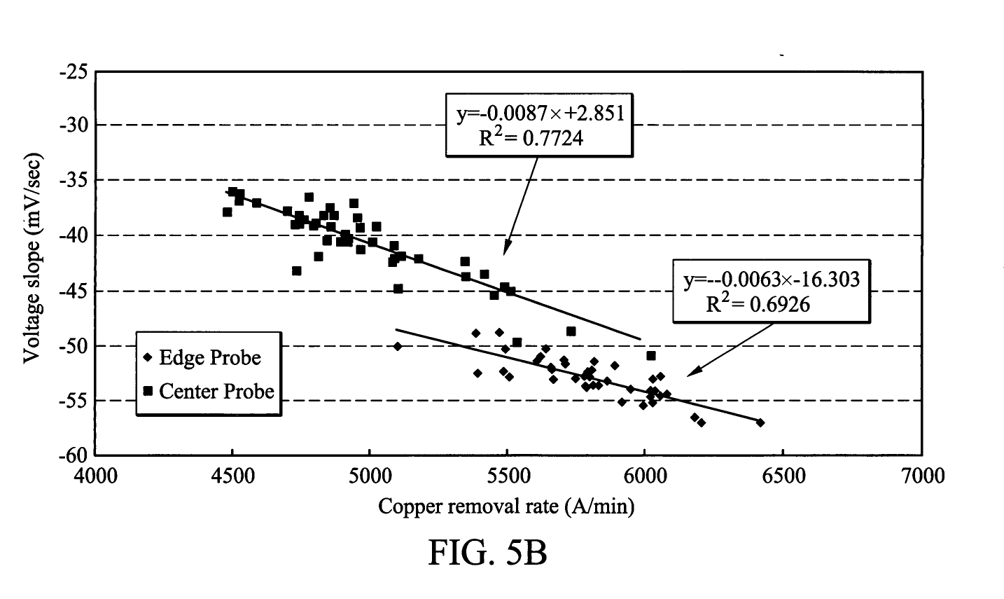

Before a polishing process is performed, a first regression model is provided, specifying correlation between residue Cu thickness and a measured electromagnetic signal (step S321). Additionally, a second regression model is provided, specifying correlation of the Cu removal rate and a change rate of the measured electromagnetic signal (step S323). According to this embodiment, the electromagnetic signal is a voltage measurement obtained by a voltmeter, and the first and second regression models are linear regression models. The first and second regression models are determined experimentally using a blank wafer. FIG. 5A illustrates a scatter plot and regression line according to a first regression model according to the embodiment. According to the first regression model, the regression equation for a testing probe disposed on an edge of the polished surface is as follows:
y=0.4638x−175.17 (Equation 1.1)
R²=0.7411

The regression equation for a testing probe disposed on the central area of the polished surface is as follows:
y=0.436x−76.99 (Equation 1.2)
R²=0.8434
According to the regression equations 1.1 and 1.2, y is voltage measurement (mV) and x is residue Cu thickness (Å).

FIG. 5B illustrates a scatter plot and regression line according to a second regression model according to this embodiment. According to the first regression model, the regression equation for a testing probe disposed on edge of the polished surface is as follows:
y=−0.0063x+16.303 (Equation 2.1)
R²=0.6926

The regression equation for a testing probe disposed on the center of the polished surface is as follows:
y=−0.0087x+2.851 (Equation 2.2)
R²=0.7724
According to the regression equations 2.1 and 2.2, y is change rate of measured voltage (mV/sec) and x is Cu removal rate (Å/min).

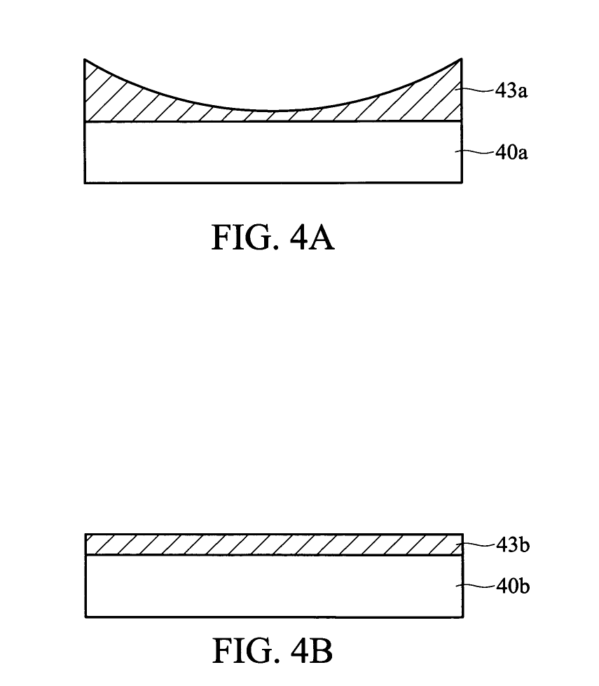

A first polishing run is then performed (step S33). The first polishing run performs a CMP process as defined by a first process parameter to remove a layer of Cu and to planarize the surface of the substrate. The first polishing run removes bulk of Cu from the substrate, leaving a slightly concave surface as shown in FIG. 4A, wherein the substrate is represented as layer 40a and the Cu layer as 43a. The concave appearance results from the variable Cu removal rate on the central and edge of the substrate. Generally, the removal rate is greater in the central area than at the edge.

The Cu film thickness measurements on the central and edge areas are then obtained using an eddy current testing device. The central and edge areas of the polished surface are inspected using central and edge testing probes, respectively.

Electromagnetic signals induced from the Cu layer on the central and edge areas are then measured by the central and edge testing probes, respectively (step S35). According to this embodiment, a voltage measurement of the induced eddy current is obtained by a voltmeter.

Residue Cu thickness is then determined according to the voltage measurement and the first regression model (step S37). The voltage measurement is then used to determine a corresponding residue Cu thickness according to the first regression model. Y in Equation 1.1 is substituted by a voltage measurement obtained by the edge testing probe, and a corresponding residue Cu thickness is then determined accordingly. Similarly, y in Equation 1.2 is substituted by a voltage measurement obtained by the central testing probe, and a corresponding residue Cu thickness is then determined accordingly.

Cu removal rate is then determined according to a change rate of the voltage measurement and the second regression model (step S39). The change rate of the voltage measurement is then determined and used to estimate a corresponding Cu removal rate according to the second regression model described above. Y in Equation 2.1 is substituted by a change rate of voltage measurement obtained by the edge testing probe, and a corresponding Cu removal rate is then determined accordingly. Similarly, Y in Equation 2.2 is substituted by a change rate of voltage measurement obtained by the central testing probe, and a corresponding Cu removal rate is then determined accordingly.

After the residue Cu thickness and the Cu removal rate for the edge and central areas are determined, a process parameter of the first process run is then adjusted accordingly (step S391).

Downward pressure applied at the edge and central areas of the polished surface are adjusted to modify Cu removal rates thereof (step S395). The polishing tool applies the adjusted downward pressure on the edge and center of the polished surface to remove Cu, and leaves a planarized Cu film without a concave appearance, as shown in FIG. 4B, wherein the substrate is represented as layer 40b and the Cu layer as layer 43b.

The method of the present invention, or certain aspects or portions thereof, may take the form of program code (i.e. instructions) embodied in a tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

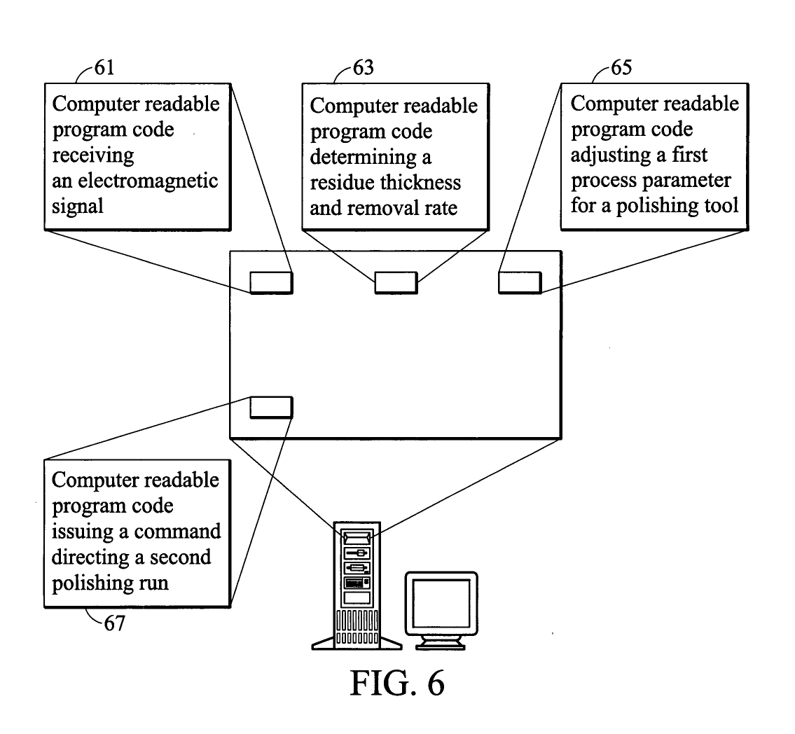

FIG. 6 is a diagram of a storage medium storing a computer program providing the process control method according to the disclosure. The computer program product comprises a computer usable storage medium having computer readable program code embodied in the medium, the computer readable program code comprising computer readable program code 61 receiving an electromagnetic signal, computer readable program code 63 determining a residue thickness and removal rate of a conductive material, computer readable program code 65 adjusting a first process parameter for a polishing tool, and computer readable program code 67 issuing a command directing a second polishing run.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fabrication system, comprising:
a polishing tool, using a mechanical mechanism to remove conductive material from a substrate;
a metrology tool, measuring an electromagnetic signal induced in the conductive material using a non-destructive testing mechanism; and
a controller, coupled to the polishing and metrology tools, determining residue thickness and removal rate of the conductive material during the polishing process according to the measured electromagnetic signal, and adjusting a first process parameter for the polishing tool accordingly.

2. The system of claim 1, wherein the polishing tool performs a chemical mechanical polishing process.

3. The system of claim 1, wherein the polishing tool performs a multi-zone polishing process, capable of applying variable downward pressure on different polishing zones.

4. The system of claim 1, wherein the conductive material is copper or any conductive materials in which non-destructive metrology can be applied.

5. The system of claim 1, wherein the metrology tool employs eddy current testing, using a voltmeter to measure the electromagnetic signal.

6. The system of claim 1, wherein the metrology employs eddy current testing, using an ammeter to measure the electromagnetic signal.

7. The system of claim 5, wherein the metrology tool comprises at least two separate testing probes disposed on at least two different polishing zones, respectively.

8. The system of claim 7, wherein the metrology tool comprises a first testing probe disposed on the central area of the polished surface and a second testing probe on an edge area thereof.

9. The system of claim 7, wherein the controller further determines the residue thickness of the conductive material according to a preset regression model specifying correlation between residue thickness of the conductive material and the measured voltage corresponding to the testing probe.

10. The system of claim 1, wherein the controller further determines the removal rate for conductive material according to a preset regression model specifying correlation of the removal rate and the change rate of the measured voltage corresponding to the testing probe.

11. The system of claim 1, further comprising a plating tool, connected to the controller, forming a metal layer on the substrate.

12. The system of claim 11, wherein the controller uses the measured residue thickness and removal rate of the conductive material to adjust a second process parameter for the plating tool accordingly.

13. A processing method, comprising:
providing a substrate covered with a layer of conductive material on a surface thereof;
performing a first polishing run, defined by a first process parameter, using a mechanical mechanism to remove the conductive material;
measuring an electromagnetic signal induced from the conductive material using a non-destructive testing mechanism;
determining a residue thickness and removal rate of the conductive material during the first polishing run according to the measured electromagnetic signal; and
adjusting the first process parameter for the polishing tool accordingly.

14. The method of claim 13, further performing a second polishing run defined by the adjusted process parameter.

15. The method of claim 13, wherein the polishing process performs chemical mechanical polishing.

16. The method of claim 13, wherein the polishing process performs multi-zone polishing, applying variable downward pressure on different polishing zones.

17. The method of claim 13, wherein the conductive material is copper.

18. The method of claim 13, wherein the electromagnetic signal is measured by eddy current testing using a voltmeter.

19. The method of claim 13, wherein the electromagnetic signal is measured by eddy current testing using an ammeter.

20. The method of claim 13, wherein the electromagnetic signal is measured by two separate testing probes disposed on different polishing zones, respectively.

21. The method of claim 20, wherein the electromagnetic signal is measured by a first testing probe disposed on the central area of the polished surface and a second testing probe disposed on an edge area thereof.

22. The method of claim 20, further determining the residue thickness of the conductive material according to a preset regression model specifying the correlation between residue thickness of the conductive material and the measured voltage corresponding to the testing probe.

23. The method of claim 20, further determining the removal rate for the conductive material according to a preset regression model specifying correlation of the removal rate and the change rate of the measured voltage corresponding to the testing probe.

24. The method of claim 13, further adjusting a second process parameter for a plating tool that forms the layer of conductive material on the substrate.

25. The method of claim 24, further performing a plating run to form a layer of conductive material on another substrate.

26. A computer readable storage medium for storing a computer program providing a method for process control, the method comprising:
receiving an electromagnetic signal induced from a conductive material measured by a non-destructive testing mechanism during a first polishing run;
determining a residue thickness and removal rate of the conductive material during the first polishing run according to the measured electromagnetic signal;
adjusting the first process parameter for the polishing tool accordingly; and
issuing a command directing a second polishing run defined by the adjusted first process parameter.

27. The storage medium of claim 26, wherein the electromagnetic signal is measured by two separate testing probes disposed on different polishing zones, respectively.

28. The storage medium of claim 26, wherein the method further determines the residue thickness of the conductive material according to a preset regression model specifying correlation between residue thickness of the conductive material and the measured voltage corresponding to the testing probe.

29. The storage medium of claim 26, wherein the method further determines the removal rate for the conductive material according to a preset regression model specifying correlation of the removal rate and the change rate of the measured voltage corresponding to the testing probe.

30. The storage medium of claim 26, wherein the method further adjusts a second process parameter for a plating tool that forms the layer of conductive material on the substrate.
